(19) United States
(12) Patent Application Publication
(10) Pub. No.: US 2026/0234976 A1
(43) Pub. Date: Aug. 13, 2026

(54) HINGE

(71) Applicant: Southco, Inc., Concordville, PA (US)

(72) Inventor: Glenn Eric Anderson, Malvern, PA (US)

(73) Assignee: Southco, Inc., Concordville, PA (US)

(21) Appl. No.: 19/161,219

(22) PCT Filed: Feb. 29, 2024
(86) PCT No.: PCT/US2024/017810

§ 371 Date: Aug. 29, 2025

Related U.S. Application Data
(60) Provisional application No. 63/449,727, filed on Mar. 3, 2023.

(51) Int. Cl. E05F 1/12

(52) U.S. Cl. CPC E05F 1/1215; E05Y 2201/26; E05Y 2201/266; E05Y 2201/484

(57) ABSTRACT

A hinge for coupling components for pivotal movement relative to one another is disclosed. The hinge includes a housing. A torque engine and a torque adjusting unit are positionable within the housing. The torque engine provides frictional resistance to pivotal movement of the coupling components, and includes a shaft and a torque element frictionally engaging the shaft. The torque adjusting unit includes a spring arbor configured to connected to the shaft when the hinge is assembled, and a spiral torsion spring wrapped around the spring arbor. The spiral torsion spring has a coiled body having a number of plurality of rotations extending between a first spring end and a second end, with the number of plurality of rotations being selected to adjust the frictional resistance.

### CROSS-REFERENCE TO RELATED APPLICATION

This application claims priority to U.S. Provisional Application No. 63/449,727, filed Mar. 3, 2023, the contents of which are incorporated herein by reference in their entirety for all purposes.

### FIELD OF THE INVENTION

The present invention relates generally to hinges or hinge modules that can be used to pivotally connect components in a system, and more specifically to a hinge module configured to counterbalance components that are movable relative to one another.

### BACKGROUND OF THE INVENTION

Various types of mechanical hinges are available to connect components in a pivoting relationship. A friction hinge, also referred to as a “constant torque hinge” or “position hinge,” is one type of hinge used on apparatuses that feature a pivoting door, panel, lid or other part that opens and closes about a pivot axis. In a typical friction hinge, a pivot shaft has an outer surface that bears against the inner surface of another part, creating mechanical interference in the hinge. This mechanical interference holds components in a stable position after they are pivoted and released, which is desirable for holding components in any position. The mechanical interference also adds a tactile “quality feel” to the movement of components, providing substantially constant resistance to rotation to improve the user experience during the closing and opening efforts.

In addition, when components are articulately connected to another for movement between first and second positions, the effective weight of the components varies as they move. In a non-limiting example, when a heavy lid is lifted from a horizontal position to a vertical position, the lid feels heaviest at the beginning of that movement and its effective weight decreases as it moves toward its vertical open position. Hence, the force necessary to move the heavy lid is greatest when the lid is horizontal. Because of the effective weight of the lid, the lid has a tendency to slam (back) into its horizontal position, usually with considerable force. Thus, counterbalance assemblies are desired in order to minimize the differences in apparent weight of the lid as it moves between the horizontal and vertical positions.

However, counterbalance assemblies typically require complex and expensive equipment, and can thus take up a considerable amount of space and add significant weight to the overall structure. Counterbalance assemblies may also include extremely bulky or heavy components, components that cannot withstand frequent use cycles, and/or components that may obstruct access into an enclosure.

### SUMMARY OF THE INVENTION

The drawbacks of conventional counterbalance hinge assemblies are addressed in many respects by hinge modules, assemblies, and systems in accordance with the invention.

In a first aspect of the invention, a counterbalance hinge module for coupling components for pivotal movement relative to one another is disclosed. The counterbalance hinge module comprises a housing. The counterbalance hinge module also includes a torque engine positionable within the housing and configured to provide frictional resistance to pivotal movement of the coupling components. The torque engine has a shaft defining a pivot axis, and a torque element frictionally engaging the shaft. The counterbalance hinge module further comprises a torque adjusting unit positionable within the housing. The torque adjusting unit has a spring arbor having a first open end configured to receive a head of the shaft when the hinge is assembled, and a spiral torsion spring configured to be wrapped around an exterior surface of the spring arbor to form a coiled body. The coiled body has a number of plurality of rotations extending between a first spring end secured to the spring arbor and a second end secured to an interior surface of the housing. The number of plurality of rotations is selected to adjust the frictional resistance.

In another aspect of the invention, a hinged system is disclosed. The hinged system includes a first component and a second component. The hinged system also includes a counterbalance hinge module that couple the first component to the second component in a pivot connection so as to allow pivotal movement of the first component relative to the second component. The counterbalance hinge module comprises a housing configured to be connected to an adapter. The counterbalance hinge module further comprises a torque engine that is positionable within the housing, and configured to provide frictional resistance to pivotal movement of the coupling components. The torque engine has a shaft defining a pivot axis, and a torque element frictionally engaging the shaft. The counterbalance hinge module includes a torque adjusting unit that is positionable within the housing. The torque adjusting unit includes a spring arbor having a first open end configured to receive head of the shaft when the hinge is assembled, and a spiral torsion spring configured to be wrapped around an exterior surface of the spring arbor to form a coiled body. The coiled body comprises a number of plurality of rotations selected to adjust the frictional resistance. Additionally, a mounting surface of the adapter is mounted to the first component, whereas a mounting portion of the housing is mounted to the second component.

### BRIEF DESCRIPTION OF THE DRAWINGS

The foregoing summary and the following description will be better appreciated and understood in conjunction with the non-limiting examples illustrated in the attached drawing figures, of which:

FIGS. 1A-1D depict views of a counterbalance hinge module in accordance with an exemplary embodiment of the invention;

FIG. 2 depicts an exploded view of the hinge module of FIGS. 1A-1D;

FIG. 3A depicts a side view of a counterbalance hinge module in accordance with another exemplary embodiment of the invention;

FIG. 3B depicts a cross section view of the hinge module of FIG. 3A taken through line 3B-3B;

FIGS. 4A-4B depict perspective views of a counterbalance hinge module in accordance with another exemplary embodiment of the invention;

FIG. 4C depicts a top view of the hinge module of FIGS. 4A-4B;

FIG. 4D depicts a cross section view of the hinge module of FIG. 4C taken through line 4D-4D;

FIG. 4E depicts a cross section view of the hinge module of FIG. 4C taken through line 4E-4E;

FIG. 4F depicts a bottom view of the hinge module of FIGS. 4A-4B;

FIG. 4G depicts a cross section view of the hinge module of FIG. 4F taken through line 4G-4G;

FIG. 4H depicts a cross section view of the hinge module of FIG. 4F taken through line 4H-4H;

FIG. 5 depicts an exploded view of the hinge module of FIGS. 4A-4B;

FIG. 6 depicts a side view of the hinge module of FIGS. 4A-4B, showing an exemplary range of movement in accordance with an exemplary embodiment of the invention;

FIGS. 7A-7B depict perspective views of a counterbalance hinge module in accordance with another exemplary embodiment of the invention;

FIG. 7C depicts a top view of the hinge module of FIGS. 7A-7B;

FIG. 7D depicts a cross section view of the hinge module of FIG. 7C taken through line 7D-7D;

FIG. 7E depicts a cross section view of the hinge module of FIG. 7C taken through line 7E-7E;

FIG. 7F depicts a bottom view of the hinge module of FIGS. 7A-7B;

FIG. 7G depicts a cross section view of the hinge module of FIG. 7F taken through line 7G-7G;

FIG. 7H depicts a cross section view of the hinge module of FIG. 7F taken through line 7H-7H;

FIG. 8 depicts an exploded view of the hinge module of FIGS. 7A-7B;

FIG. 9 depicts a side view of the hinge module of FIGS. 7A-7B, showing an exemplary range of movement in accordance with an exemplary embodiment of the invention;

FIGS. 10A-10B depict perspective views of a counterbalance hinge module in accordance with another exemplary embodiment of the invention;

FIG. 10C depicts a top view of the hinge module of FIGS. 10A-10B;

FIG. 10D depicts a cross section view of the hinge module of FIG. 10C taken through line 10D-10D;

FIG. 10E depicts a cross section view of the hinge module of FIG. 10C taken through line 10E-10E;

FIG. 10F depicts a bottom view of the hinge module of FIGS. 10A-10B;

FIG. 10G depicts a cross section view of the hinge module of FIG. 10F taken through line 10G-10G;

FIG. 10H depicts a cross section view of the hinge module of FIG. 10F taken through line 10H-10H;

FIG. 11 depicts an exploded view of the hinge module of FIGS. 10A-10B;

FIG. 12 depicts a side view of the hinge module of FIGS. 10A-10B, showing an exemplary range of movement in accordance with an exemplary embodiment of the invention;

FIGS. 13A-3B depict perspective views of a counterbalance hinge module in accordance with another exemplary embodiment of the invention;

FIG. 13C depicts a top view of the hinge module of FIGS. 13A-13B;

FIG. 13D depicts a cross section view of the hinge module of FIG. 13C taken through line 13D-13D;

FIG. 13E depicts a cross section view of the hinge module of FIG. 13C taken through line 13E-13E;

FIG. 13F depicts a bottom view of the hinge module of FIGS. 13A-13B;

FIG. 13G depicts a cross section view of the hinge module of FIG. 13F taken through line 13G-13G;

FIG. 13H depicts a cross section view of the hinge module of FIG. 13F taken through line 13H-13H;

FIG. 14 depicts an exploded view of the hinge module of FIGS. 13A-13B;

FIG. 15 depicts a side view of the hinge module of FIGS. 13A-13B, showing an exemplary range of movement in accordance with an exemplary embodiment of the invention;

FIG. 16A depicts a perspective view of a counterbalance hinge module in accordance with another exemplary embodiment of the invention;

FIG. 16B depicts a top view of the hinge module of FIG. 16A;

FIG. 16C depicts a cross section view of the hinge module of FIG. 16B taken through line 16C-16C;

FIG. 16D depicts a cross section view of the hinge module of FIG. 16B taken through line 16D-16D;

FIG. 16E depicts a cross section view of the hinge module of FIG. 16B taken through line 16E-16E;

FIG. 16F depicts a cross section view of the hinge module of FIG. 16B taken through line 16F-16F;

FIG. 16G depicts a cross section view of the hinge module of FIG. 16B taken through line 16G-16G;

FIG. 16H depicts a cross section view of the hinge module of FIG. 16B taken through line 16H-16H;

FIG. 16I depicts a cross section view of the hinge module of FIG. 16B taken through line 161-161;

FIG. 16 depicts a side view of the hinge module of FIG. 16A;

FIG. 16K depicts a cross section view of the hinge module of FIG. 16J;

FIG. 17A depicts a perspective view of a counterbalance hinge module in accordance with another exemplary embodiment of the invention;

FIG. 17B depicts a top view of the hinge module of FIG. 17A;

FIG. 17C depicts a cross section view of the hinge module of FIG. 17B taken through line 17C-17C;

FIG. 17D depicts a cross section view of the hinge module of FIG. 17B taken through line 17D-17D;

FIG. 17E depicts a cross section view of the hinge module of FIG. 17B taken through line 17E-17E;

FIG. 17F depicts a cross section view of the hinge module of FIG. 17B taken through line 17F-17F;

FIG. 17G depicts a cross section view of the hinge module of FIG. 17B taken through line 17G-17G; and

FIG. 17H depicts a cross section view of the hinge module of FIG. 17B taken through line 17H-17H;

FIGS. 18A-18I depict views of an exemplary housing in accordance with aspects of the invention;

FIGS. 19A-19F depict views of an exemplary spring arbor in accordance with aspects of the invention;

FIGS. 20A-20D depict views of an exemplary spiral torsion spring in accordance with aspects of the invention;

FIGS. 21A-21H depict views of an exemplary adapter in accordance with aspects of the invention;

FIGS. 22A-22G depict views of another exemplary adapter in accordance with aspects of the invention;

FIGS. 23A-23H depict views of still another exemplary adapter in accordance with aspects of the invention; and

FIGS. 24A-24H depict views of yet another exemplary adapter in accordance with aspects of the invention.

### DETAILED DESCRIPTION

Although the invention is illustrated and described herein with reference to specific embodiments, the invention is not intended to be limited to the details shown. Rather, various modifications may be made in the details within the scope and range of equivalents of the claims and without departing from the invention.

Additionally, various forms and embodiments of the invention are illustrated in the figures. It will be appreciated that the combination and arrangement of some or all features of any of the embodiments with other embodiments is specifically contemplated herein. Accordingly, this detailed disclosure expressly includes the specific embodiments illustrated herein, combinations and sub-combinations of features of the illustrated embodiments, and variations of the illustrated embodiments.

Generally, a counterbalance mechanism is provided by this invention, including embodiments that utilize a customizable mechanism for generating a counter acting force to the center of gravity of a system or assembly (e.g., an enclosure having a movable panel, e.g. a bulky or heavy-duty door/hood/lid). It should be understood that the counterbalance hinge module or assembly can be utilized in a variety of applications. In addition, the counterbalance assembly as a whole can be comprised of a plurality of counterbalance hinge modules, and they do not all have to be mounted in the same orientation, depending on the particular application. Non-limiting examples of applications of the counterbalance hinge module or assembly are panels, vehicle hoods, such as on trucks or cars, heavy doors or lids of containers or compartments, either in a vehicle or in other applications which require the use of heavy doors or covers that need to be periodically opened and closed, such as lids on a dumpster, bulkhead doors, etc. Also, this invention can be used for any application in which the perceived weight of a component is modified (decreased or increased) at any point along its movement relative to another component.

In one aspect of the invention, one or more components of the hinge module can be designed, selected, or shaped to impart to the system or assembly the desired overall counterbalancing characteristics, such as, for example, a neutral counterbalancing. In general, the counterbalance mechanism is designed to provide a customizable progressive torque (i.e. rotational force), which applies a counteracting force to the weight of the system about its point of rotation, in order to achieve the desired overall counterbalancing characteristics (e.g. neutral). The amount of progressive torque supplied by the torsion element(s) from stored energy can be adjusted within an optimum range amount.

Significant advantage is imparted by the ability of the system to be customized, at least in terms of adjustability of the torque and range of pivotal motion of the coupling components. When a pair of hinge modules are provided, the torque supplied by respective hinge modules can be separately adjusted while the hinge module is mounted in place, so it is easy to adjust the torque if necessary. For instance, if one or more of the coupling components are heavier on one side, or if the pair of hinge modules cannot be mounted symmetrically, each hinge module can be separately adjusted around a different range of torque outputs.

Further, the adjustability of the torque output can permit customization of the operability of the system or assembly during manufacture or assembly. As a non-limiting example, the system could store energy such that a heavy/bulky/large lid (or panel, hood, door or other component, etc.) could be locked closed, but when unlocked, automatically “pops” open, or slowly rises open. The torque output could also be adjusted such that the heavy/bulky/large lid could have a neutral balance point along its travel path between a first (e.g. fully closed) position and a second position (e.g. fully closed). For instance, the heavy/bulky/large lid effectively may feel weightless all along its travel path. In another example, the torque output could be adjusted such that the heavy/bulky/large lid would automatically close at some point along the travel path.

Referring generally to the figures, the counterbalance hinge module utilizes a torque-generation part (e.g., a torque engine), which generates an adjustable or customizable torque output from stored energy provided by an energy storage part (e.g. a torque adjusting unit). As will be discussed further below, the counterbalance hinge module or assembly may be incorporated in a system, where in the closed position, the movable component (e.g. heavy lid) is generally horizontal, and when pulled open from the top or otherwise moved toward an open position, pivots to a more vertical position. However, it should be understood from the description herein that the opposite configuration is also within the scope of the invention, i.e. the movable component (e.g. heavy lid) is generally vertical, and when pulled open from the bottom or otherwise moved toward an open position, pivots to a more horizontal position.

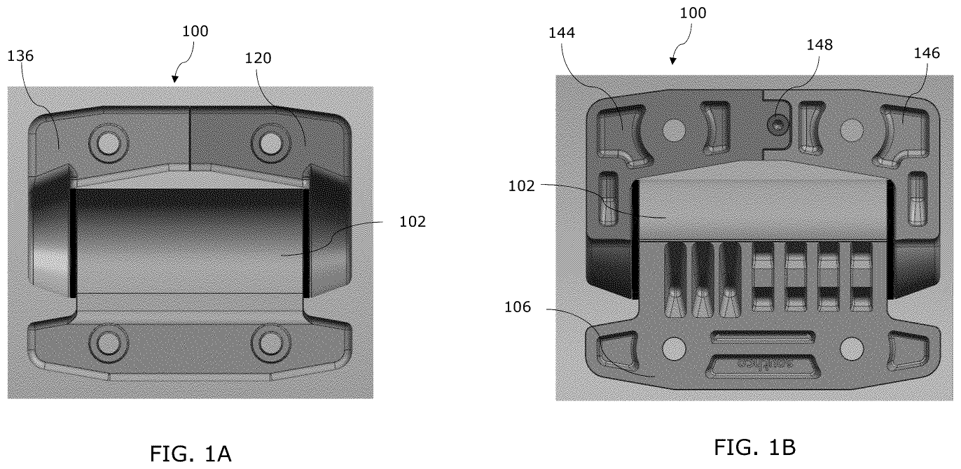

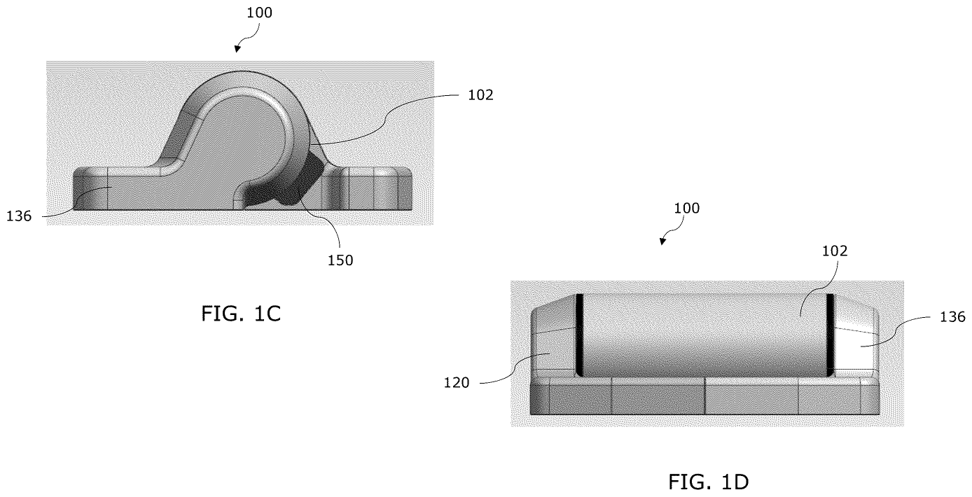

Referring generally to FIGS. 1A-3B, and according to one aspect of the invention, a counterbalance hinge module 100 for coupling components for pivotal movement relative to one another is disclosed. In a non-limiting example, the coupling components comprise a movable first component (e.g. a heavy lid of a box or housing or enclosure) and a second component (e.g. a frame or a sidewall of the box or housing or enclosure). A counterbalance assembly 1000 may comprise two hinge modules 100.

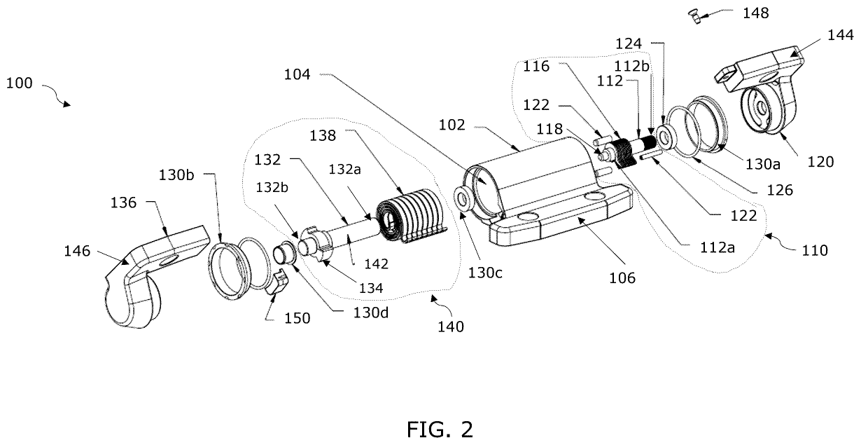

As best shown in FIGS. 1A-1C and 2, the counterbalance hinge module 100 comprises a housing 102 configured to enclose or house one or more components of the hinge module 100. Non-limiting examples of the housing 102 material includes metal (e.g. stainless steel, etc.), polymeric or plastic components, and combinations thereof. In an exemplary embodiment, housing 102 comprises a die cast aluminum housing.

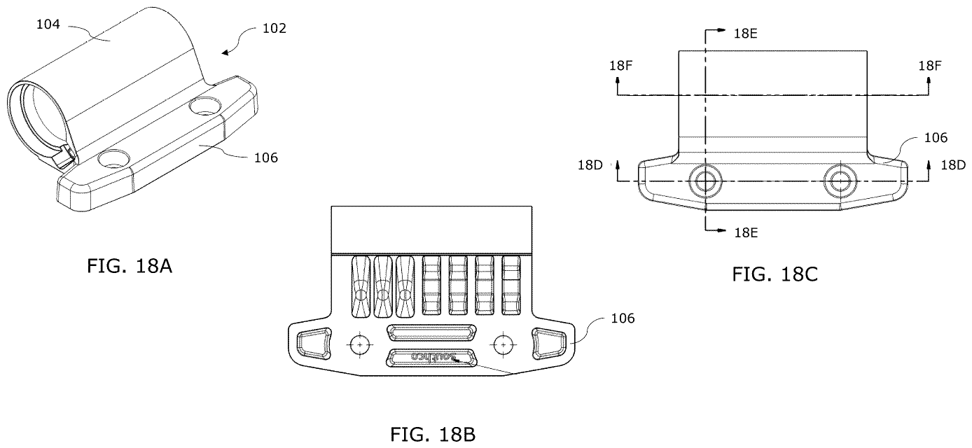

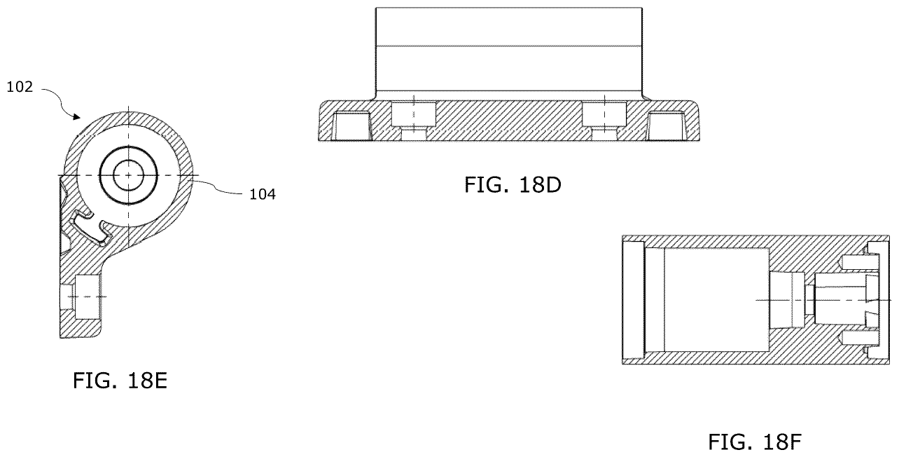

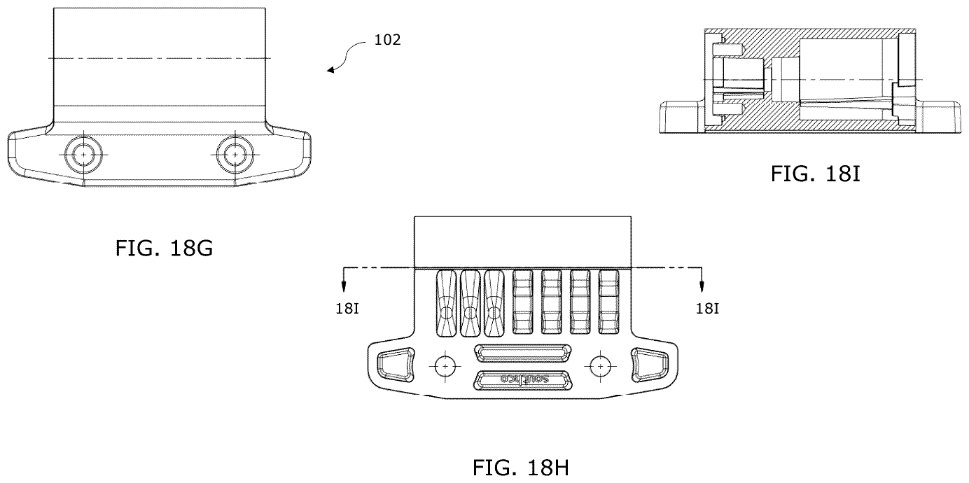

As best illustrated in FIGS. 18A-18I, in another exemplary embodiment, the housing 102 has a hollow portion 104 and a mounting portion 106. The hollow portion 104 is depicted in the figures as being generally cylindrical, but the geometry of the hollow portion 104 may be selected based on the characteristics of one or more components of the hinge module 100. In a non-limiting example, the geometry of the hollow portion 104 may be based on the size and shape of one or more components of the hinge module 100 configured to be contained therein (discussed further below). The mounting portion 106 includes a mounting surface configured for fixed coupling with one of the coupling components. As such, the mounting surface of the mounting portion 106 may have a size, shape, or structure depending on a feature (e.g. exterior surface, etc.) of one of the coupling components. In an exemplary embodiment, the mounting portion 106 includes a plurality of holes configured to receive a fastener or other known attachment mechanisms for coupling the housing 102 to one of the coupling components.

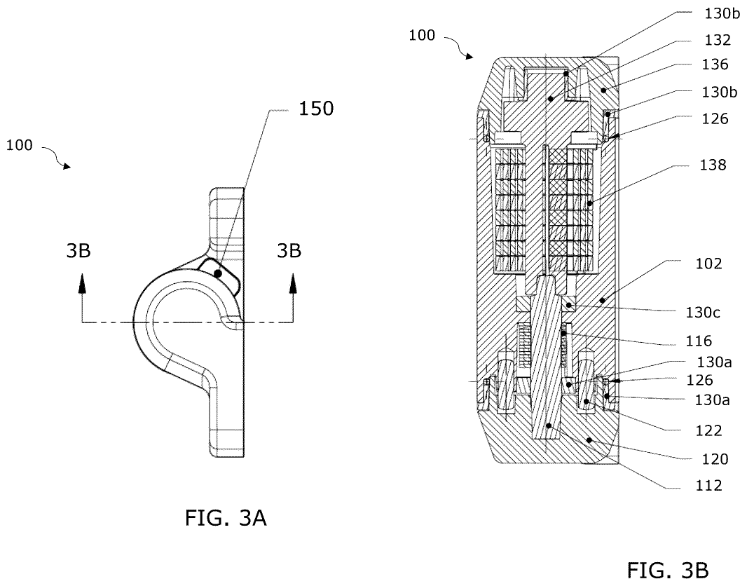

Turning now to FIGS. 2 and 3A-3B, in an exemplary embodiment, the hinge module 100 includes a torque generation part, such as a torque engine 110. The torque engine 110 comprises a shaft 112 defining a pivot axis 114. Shaft 112 has a proximal end 112a and a distal end 112b opposite the proximal end 112a. Proximal end 112a includes a head 118 having a reduced diameter relative to other sections of shaft 112. Distal end 112b defines a coupling surface such as a spline or knurled surface, which can cooperate with a first adapter 120 (discussed below), which corresponds to a first mounting location for connecting the hinge module 100 to one of the coupling components. In an exemplary embodiment, the first adapter 120 comprises a mounting surface 144 configured to be connected to a first coupling component.

The torque engine 110 further comprises a torque element 116 frictionally engaging the shaft 112. In an exemplary embodiment, the torque element 116 is configured to generate an asymmetric torque. Additionally or optionally, the torque element 116 has sickle shape or an omega shape. The amount of frictional resistance provided by torque element 116 depends in part on the amount of surface area of the torque element 116 that contacts shaft 112. Accordingly, the thickness of a single torque element 116 can be varied to change the frictional resistance. Also, the respective dimensions (e.g. outer dimension of the shaft 112 and inner dimension of the torque element 116) can be modified to increase or decrease the frictional resistance. For example, the amount of frictional resistance provided by hinge module 100 can be increased by placing plural or additional torque elements 116 within housing 102 to increase the total thickness of torque elements 116, and/or by replacing torque element 116 with a thicker torque element having a greater surface area in contact with shaft 112.

The torque engine 110 is positionable within the housing 102. In an exemplary embodiment, the housing 102 is sized and shaped to at least receive a torque element 116 or a plurality of torque elements 116. The torque engine 110 may be secured within housing 102 and to adapter 120 via knowing attachment mechanisms. Additionally or optionally, hinge module 100 bushing 124 in cooperation with the rotating or sliding shaft 112 to improve efficiency and/or reduce vibration and noise from use or operation of hinge module 100. Additionally or optionally, hinge module 100 includes polymer sleeve bearings 130 for radial support of one or more components of the hinge module 100. In an exemplary embodiment, pins 122 work in concert with internal hard stops (FIG. 3B) to limit a range of motion of the coupling components, thereby improving the “quality feel” or user feel when operating the hinge module 100. Non-limiting examples of the pins 122 include metallic dowel pins to define a travel path of the coupling components (i.e. providing hinge travel angle hard stop limits). Additionally or optionally, O-ring seals 126 may be used for preventing entry of unwanted debris or contaminants into housing 102.

FIG. 2 illustrates the plural torque elements 116 as being arranged in a first orientation. However, one skilled in the art would understand that the plural torque elements 116 may be arranged in a second orientation that is different from the first orientation. It should also be understood that the plural torque elements 116 may be arranged in any combination of the first and second orientations. The orientation of the plural torque elements 116 can be used to provide symmetrical torque (same frictional resistance in both directions of rotation) or asymmetrical torque (different frictional resistances in opposite directions of rotation). For example, if all torque elements 116 are positioned or oriented in the same direction, then the torque elements 116 will typically provide asymmetrical torque. Alternatively, if equal numbers of torque elements 116 are positioned or oriented in the opposite direction, then the torque elements 116 will typically provide symmetrical torque. Further, it should be understood that the more torque elements 116 are included, the greater the torque provided.

In addition, in an exemplary embodiment, the hinge module 100 includes an energy storage part, such as a torque adjusting unit 140. In general, the torque adjusting unit 140 provides or transfers stored energy from spiral torsion spring 138 and a spring arbor 132 to the movable adapters 120, 136, thereby facilitating a progressive torque output to a hinged system via torque engine 110.

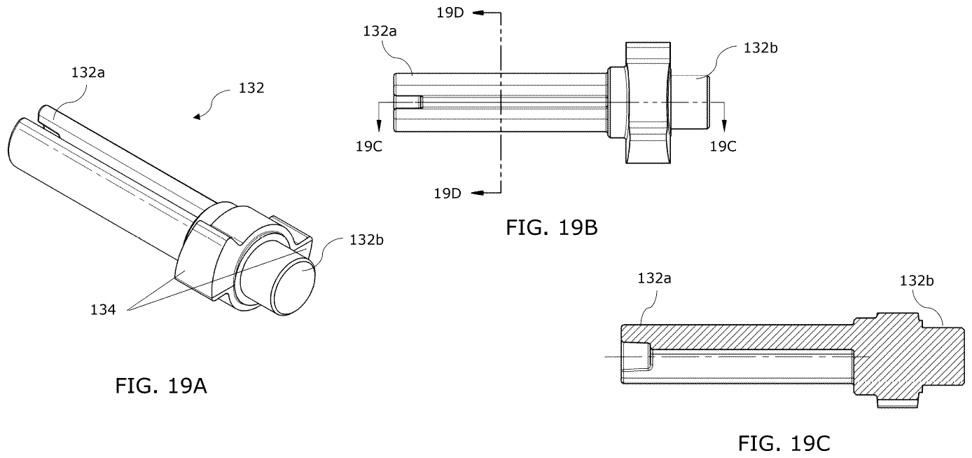

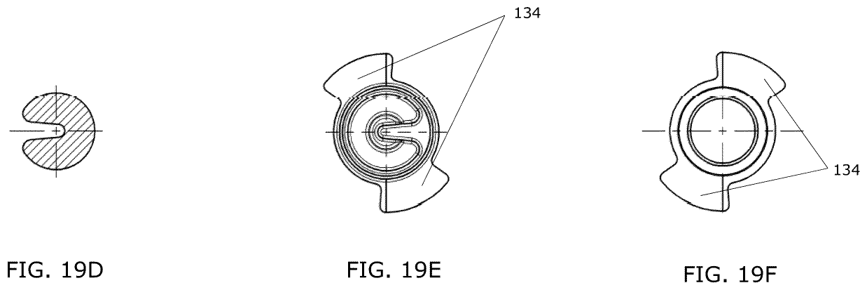

The torque adjusting unit 140 is positionable within the housing 102. The torque adjusting unit 140 comprises the spring arbor 132. In an exemplary embodiment, as shown in FIGS. 19A-19F, spring arbor 132 has a first open end 132a and a head 132b opposite the first open end 132a. In an exemplary embodiment, the spring arbor 132 comprises metal. The head 132b includes flange portions 134 configured to interact with an interior surface of a second adapter 136.

Generally, the second adapter 136 comprises a mounting surface 146 corresponding to a second mounting location for connecting the hinge module 100 to one of the coupling components. In an exemplary embodiment, the second adapter 136 is configured for fixed coupling with the distal end 112b of the shaft 112, whereas the first adapter 120 is configured for fixed coupling with the head 132b of the spring arbor 132. In still another exemplary embodiment, the first adapter 120 and second adapter 136 are separate components configured to be attached via known attachment mechanisms, such as screw or fastener 148 (FIG. 2). Alternatively, the first adapter 120 and second adapter 136 are integrally made as a unitary body. Additionally or optionally, one of the first adapter 120 and the second adapter 136 include indicia corresponding to the first or second mounting location, respectively. In an exemplary embodiment, the indicia comprises end cap 150 (FIGS. 2 and 3A). Further, when the first adapter 120 and second adapter 136 are configured to be coupled to the first coupling component, the mounting portion 106 of the housing 102 is configured to be coupled to the second coupling component, which is different from the first coupling component. In an exemplary embodiment, the first coupling component is movable relative to the second coupling component, e.g. by pivotable movement. The alternative configuration (i.e. the first adapter 120 and second adapter 136 are configured to be coupled to the second coupling component and the mounting portion 106 of the housing 102 is configured to be coupled to the first coupling component) is also possible.

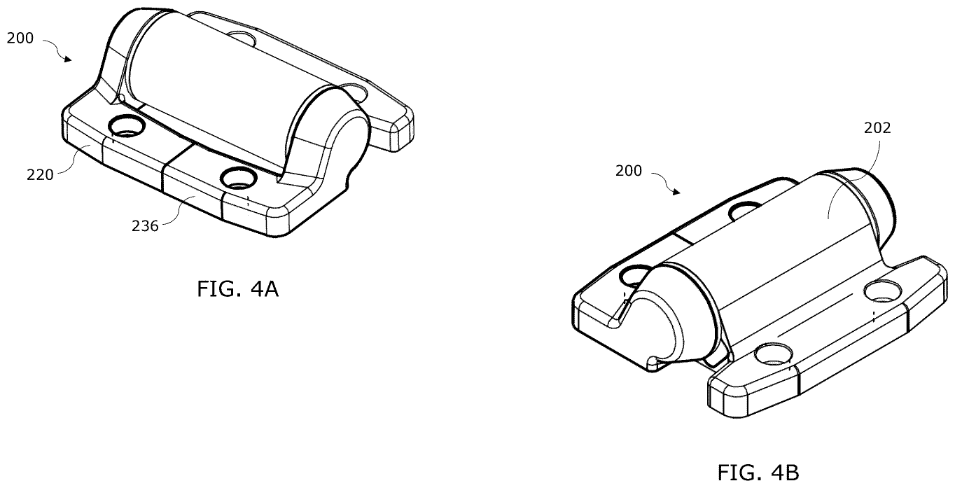

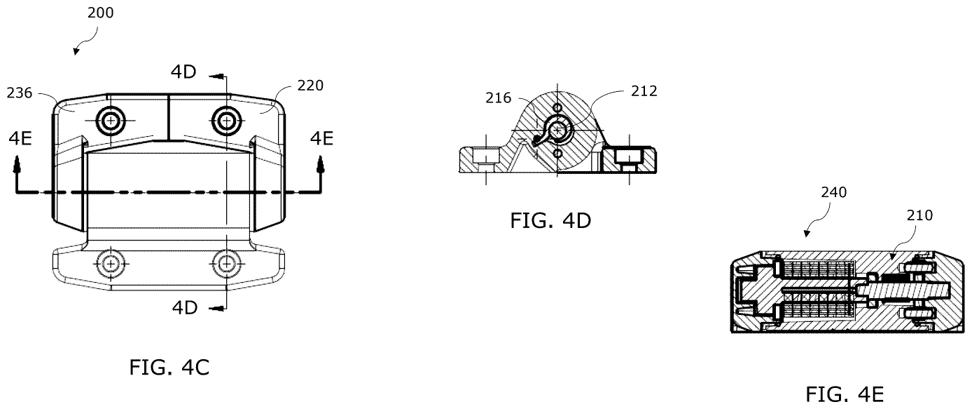

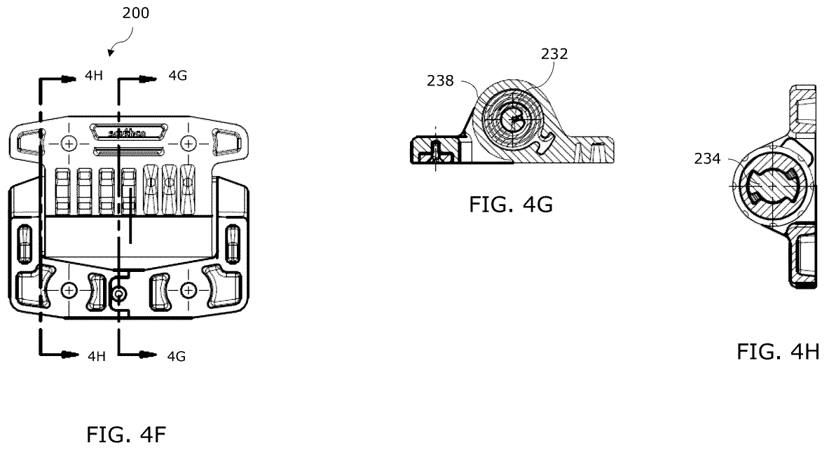

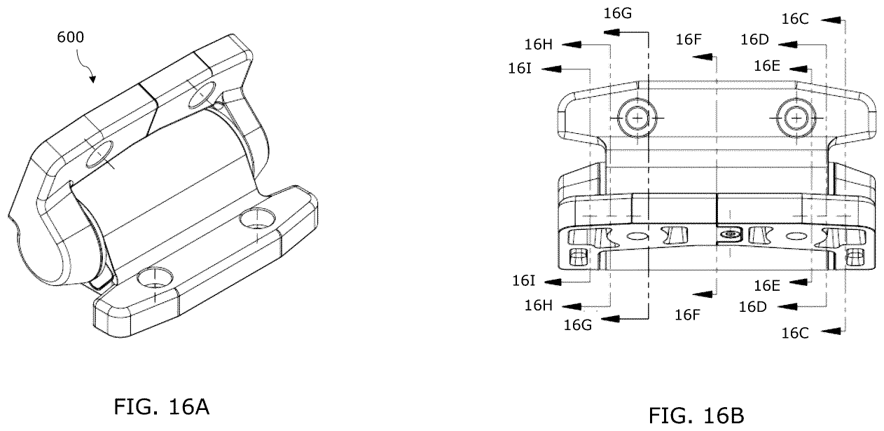

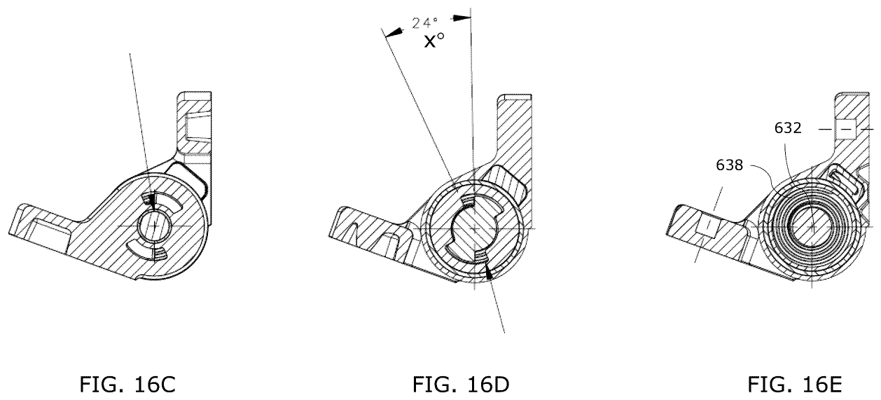

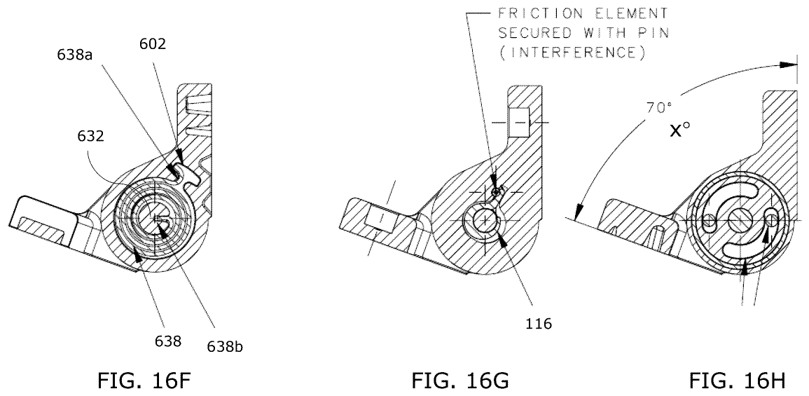

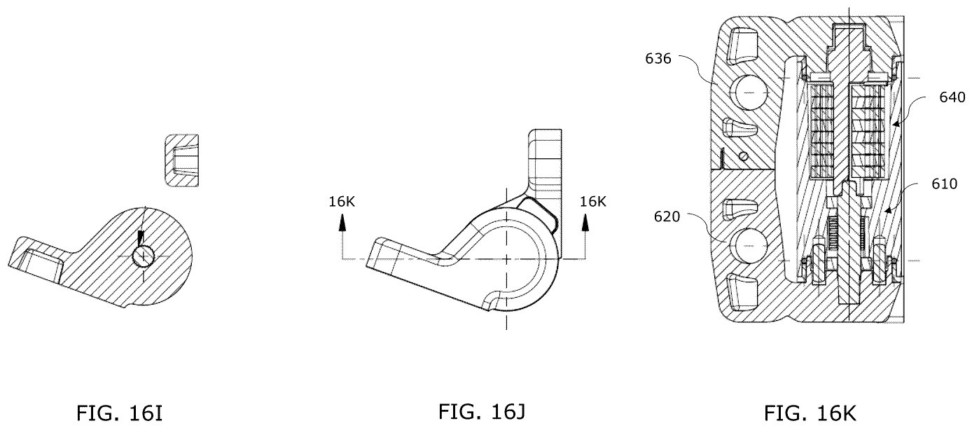

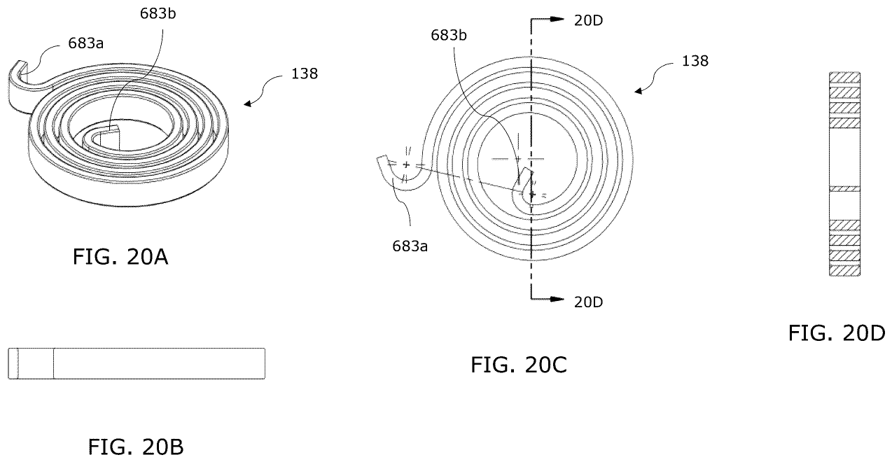

Further, and as best illustrated in FIG. 2, the first open end 132a of the spring arbor 132 is configured to receive a portion of the shaft 112 when the hinge module 100 is assembled. In an exemplary embodiment, the first open end 132a is configured to receive head 118 of shaft 112. The torque adjusting unit 140 also comprises a spiral torsion spring 138 (FIGS. 20A-20D) configured to be wrapped around an exterior surface 142 of the spring arbor 132. In an exemplary embodiment, the hollow portion of housing 102 is sized and shaped to complement the geometry of the spiral spring 138. As best illustrated in FIGS. 20A-20D, spiral torsion spring 138 includes a plurality of rotations extending between a first spring end 638a and a second spring end 638b (i.e. spring axial length=length between the first spring end 638a and second spring end 638b). The first spring end 638a (FIG. 16F) is secured to the spring arbor 132 and the second spring end 638b is secured to an interior surface of the housing 102 (see, for example, FIGS. 4G, 7G, 10G, and 13G). The spiral torsion spring 138 is configured to wrap around the exterior surface 142 of the spring arbor 132 for the number of plurality of rotations, thereby forming a coiled body. In a non-limiting example, the number of plurality of rotations is eight active coils (8). Although the torque is provided by a torque engine 110 from stored energy provided by coil torsion spring 138, it can be appreciated by those with skill in the art that additional torsional elements (e.g., a member that is designed to provide torque) could additionally comprise a flat bar, a bundle of flat bars, or a wire bundle and an exterior tube, as non-limiting examples.

In operation, the first and second coupling components of a hinged system are generally configured for pivotal movement relative to one another along a first rotational direction (e.g. clockwise) or a second rotational direction (e.g. counterclockwise). Still further, the first and second coupling components are generally configured for pivotal movement relative to one another between a first position (e.g. fully closed position) and a second position (e.g. a fully open position). In an exemplary embodiment, lubricant (e.g. grease) is applied to the inner surface of the housing 102, the torsion adjusting unit 140, the torque engine 110, or a combination thereof in order to facilitate effective pivotal movement of the coupling components.

In accordance with an aspect of this invention, torque output is customizable or adjustable during manufacture or assembly. To achieve this, one or more components of hinge module 100 may be modified or adjusted based on the desired counterbalance characteristic for the hinged system, for example. In an exemplary embodiment, the number of plurality of rotations of the spiral torsion spring 138 is selected to adjust the frictional resistance to pivotal movement of the coupling components. It should be understood that the higher the number of plurality of rotations, the greater the torque provided. Additionally or optionally, an outer diameter (OD) of the coiled body of the spiral torsion spring 138 is selected to adjust the frictional resistance. In yet another exemplary embodiment, the head 132b of the spring arbor 132 has a geometry being selected to adjust the torque rate output. Additionally or optionally, the head 132b of the spring arbor 132 has a geometry being selected to adjust the pivotal movement of the coupling components between the first rotational direction and the second rotational direction, thereby permitting the rotational direction to be reversible.

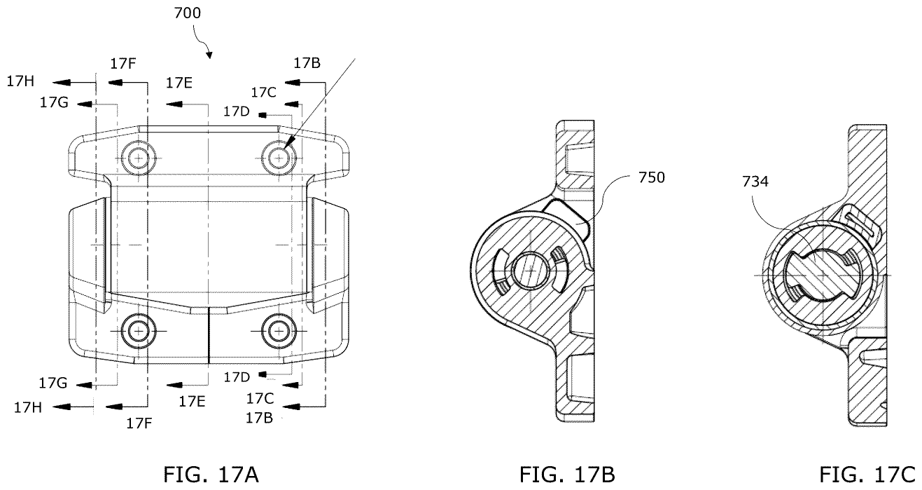

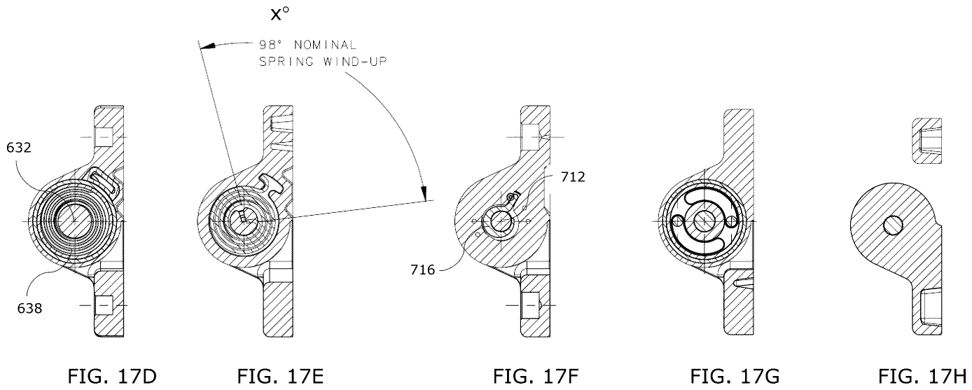

In an exemplary embodiment, at least one of the number of plurality of rotations of the spiral torsion spring 138 and the OD of the spiral torsion spring 138 is selected to adjust the pivotal movement between the first rotational direction and the second rotational direction, thereby permitting the rotational direction to be reversible. Additionally or optionally, at least one of the number of plurality of rotations of the spiral torsion spring 138 and the OD of the spiral torsion spring 138 is selected to adjust a maximum operational angle (x°) (see for example, FIGS. 16D, 16H, and 17E) between the first and second coupling components at the fully closed position or at the fully open position. In an exemplary embodiment, the spring 138 rate may be selected to adjust the maximum operational angle (x°) corresponding to the range of motion of the hinge module 100 between the fully closed position and the fully open position. It should be understood from the description herein that lowering the compression-extension spring rate would increase the range of motion of the hinge module 100.

One would understand from the description herein that the exemplary hinge for coupling components for pivotal movement relative to one another is not limited to the illustrated examples. Multiple types of hinges (e.g. a free-swinging hinge, a torque or friction hinge, a detent hinge, a removeable hinge, a concealed hinge, a barrel down hinge, and 180-degree fold flat hinge, etc.) having a housing, an exemplary torque engine positioned within the housing, and/or an exemplary torque adjuster positioned within the housing, as discussed above, would be within the spirit and scope of the invention.

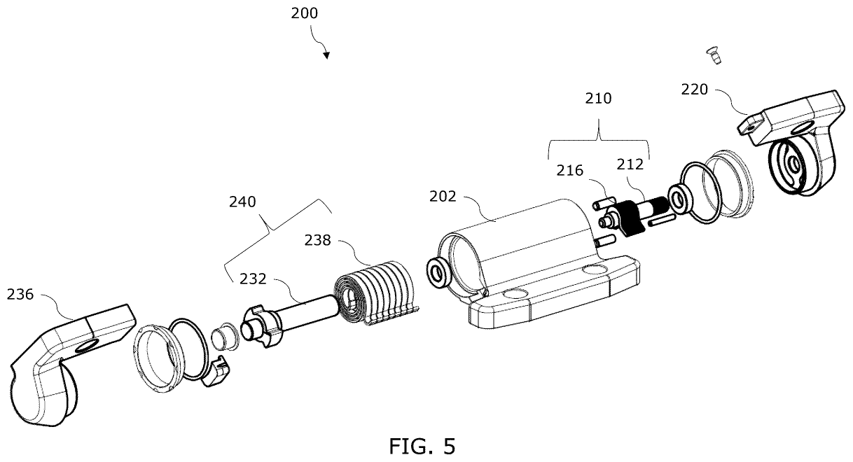

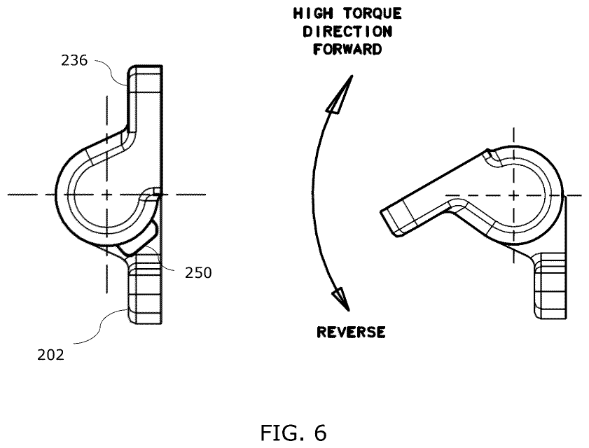

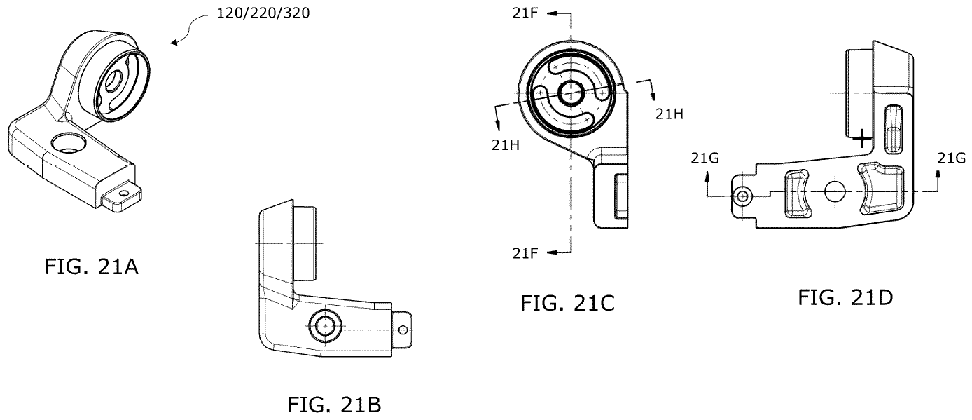

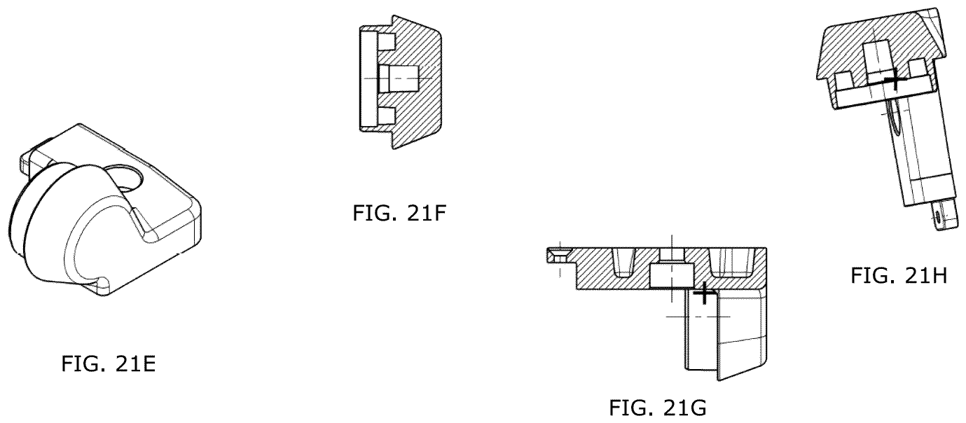

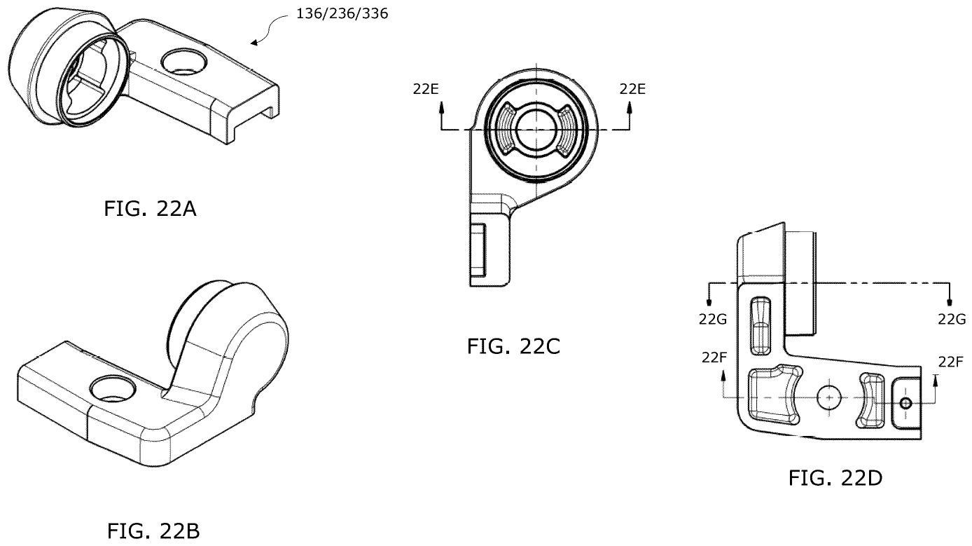

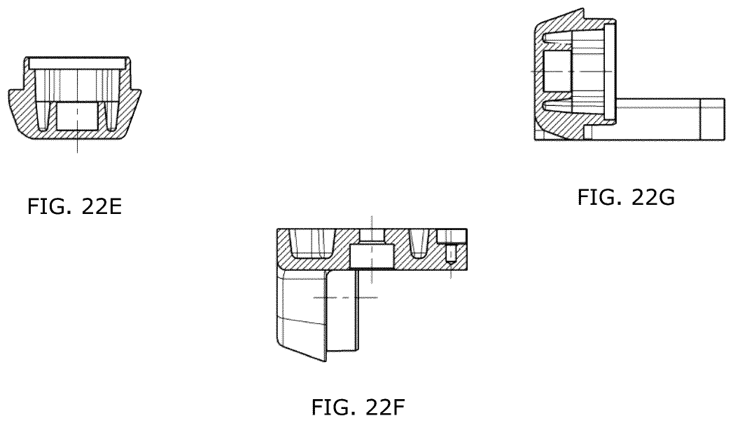

With reference to FIGS. 4A-4H, 5, and 6, a counterbalance hinge module in accordance with a second exemplary embodiment of the invention, showing the range of motion of a hinge module 200, is illustrated. The hinge module 200 is depicted in FIGS. 4A-4H, 5, and 6, and the details thereof generally correspond to the hinge module 100 as described above. For example, hinge module 200 comprises a housing 202; a torque engine 210 comprising shaft 212 and torque element 216; a torque adjusting unit 240 comprising spring arbor 232 and spring 238; and movable adapters 220, 236. Hinge module 200 comprises end cap 250 (FIG. 6) and spring arbor 232 comprises flange portions 234. Each of the components of hinge module 200 generally has similar details and function of the corresponding components of hinge module 100, such as torque engine 110 comprising shaft 112 and torque element 116; a torque adjusting unit 140 comprising spring arbor 132 and spring 138; movable adapters 120, 136; end cap 150; and flange portions 234. However, they may differ from other described embodiments in some respects. In an exemplary embodiment, movable adapter 220 is illustrated in FIGS. 21A-21H and movable adapter 236 is illustrated in FIGS. 22A-22F. For example, the maximum operational angle (x°) between the first and second coupling components at the fully closed position or at the fully open position may different from the shown and/or described (e.g. in FIGS. 16D, 16H, and 17E).

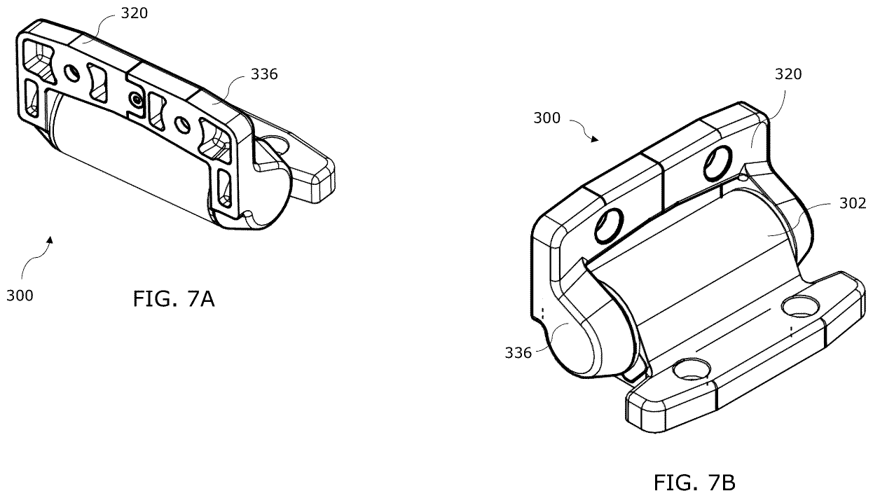

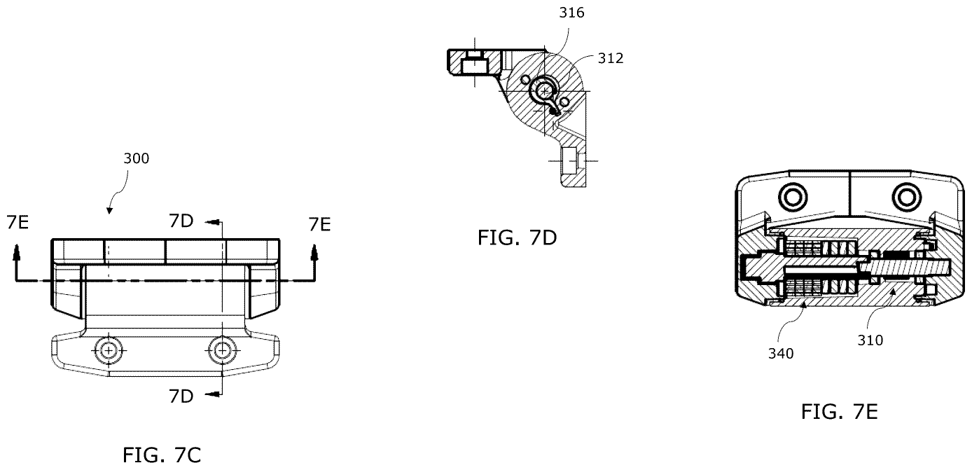

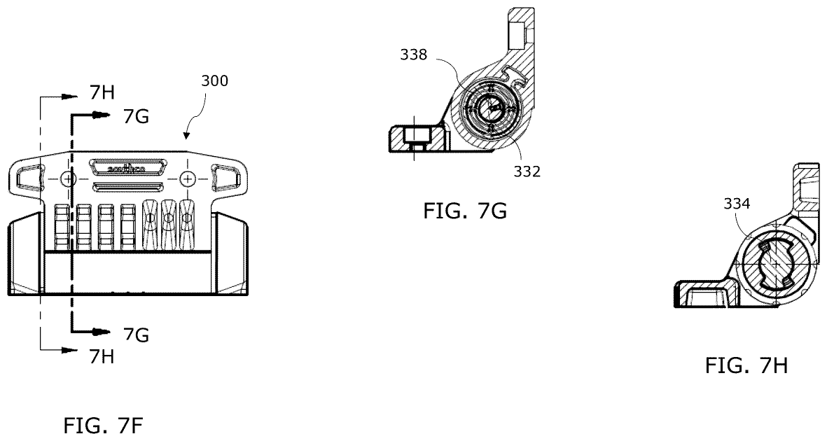

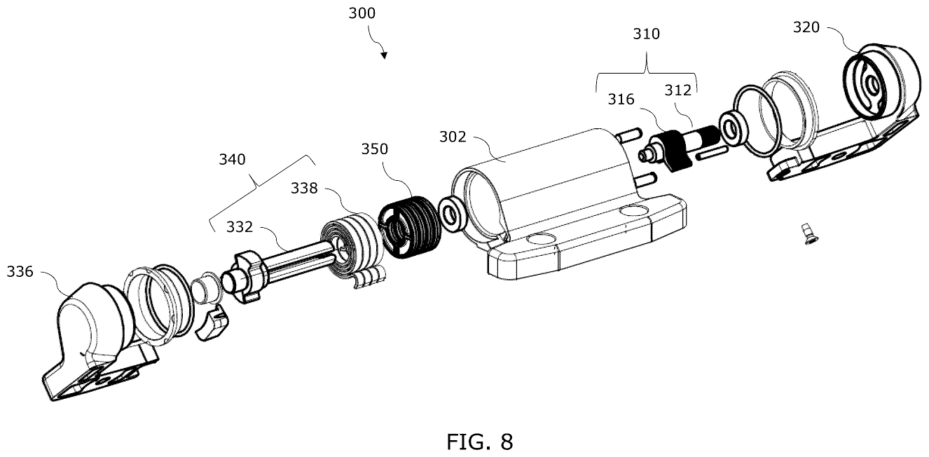

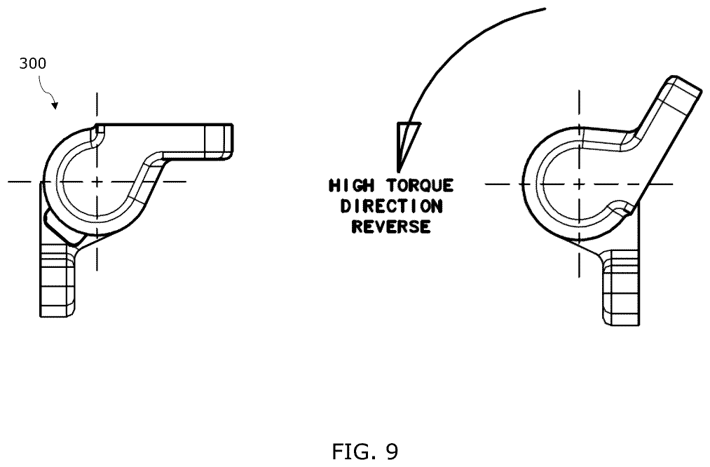

With reference to FIGS. 7A-7H, 8, and 9, a counterbalance hinge module in accordance with a third exemplary embodiment of the invention, showing the range of motion of a hinge module 300, is illustrated. The hinge module 300 is depicted in FIGS. 7A-7H, 8, and 9, and the details thereof generally correspond to the hinge module 100, 200 as described above. For example, hinge module 300 comprises a housing 302; a torque engine 310 comprising shaft 312 and torque element 316; a torque adjusting unit 340 comprising spring arbor 332 and spring 338; and movable adapters 320, 336. Hinge module 300 also comprises flange portions 334. Each of the components of hinge module 300 generally has similar details and function of the corresponding components of hinge module 100 and/or 200, such as torque engine 110 comprising shaft 112 and torque element 116; a torque adjusting unit 140 comprising spring arbor 132 and spring 138; movable adapters 120, 136; and flange portions 234. However, they differ in some respects. For example, the number of plurality of rotations is less than eight active coils (8). Accordingly, to partially or entirely fill in a resulting void within the housing 102, a cylindrical spacer 350 (FIG. 8) is positionable adjacent the spiral torsion spring 138. In an exemplary embodiment, movable adapter 320 is illustrated in FIGS. 21A-21H and movable adapter 336 is illustrated in FIGS. 22A-22F. For example, the maximum operational angle (x°) between the first and second coupling components at the fully closed position or at the fully open position may different from that shown and/or described (e.g. in FIGS. 16D, 16H, and 17E).

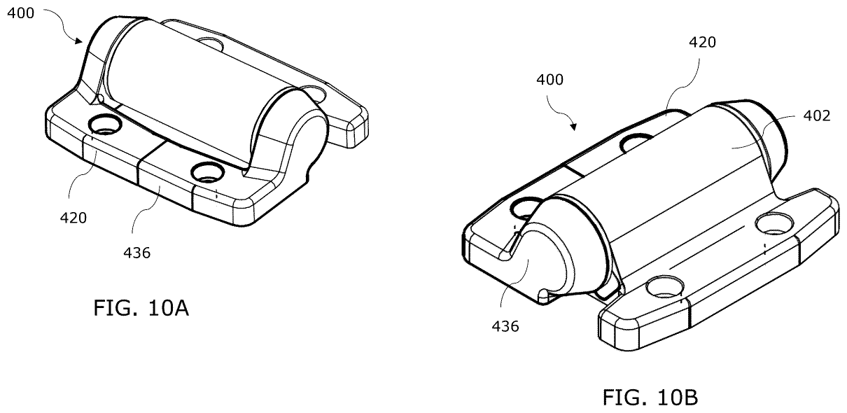

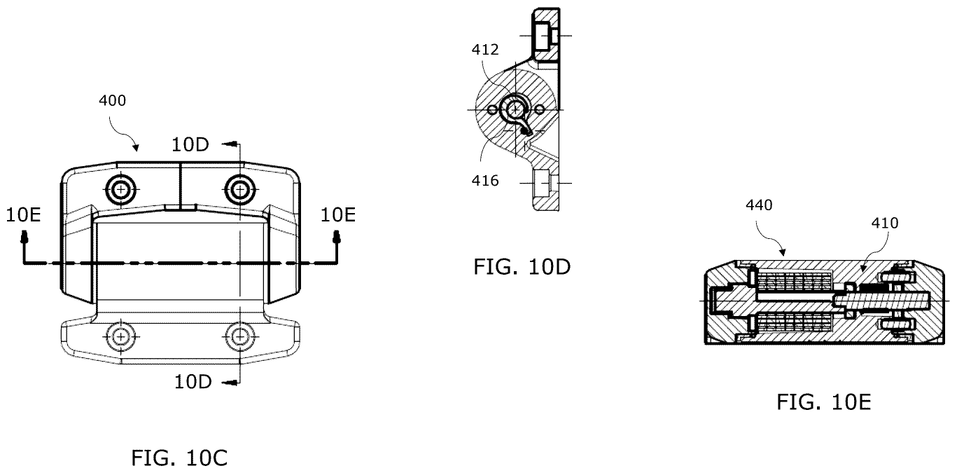

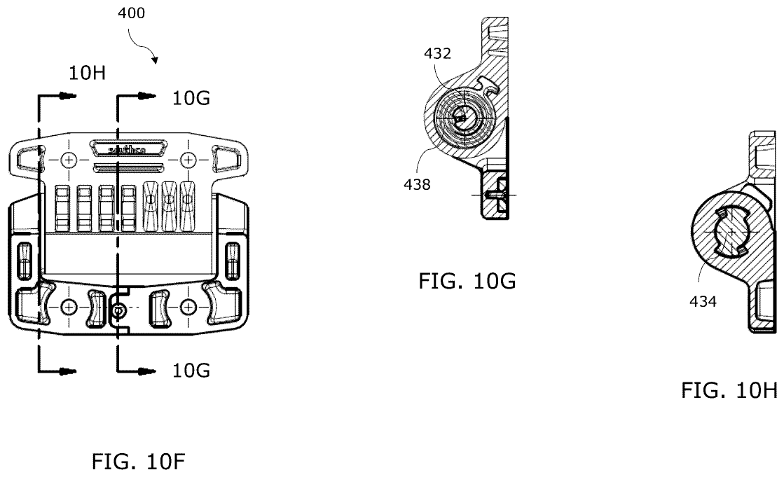

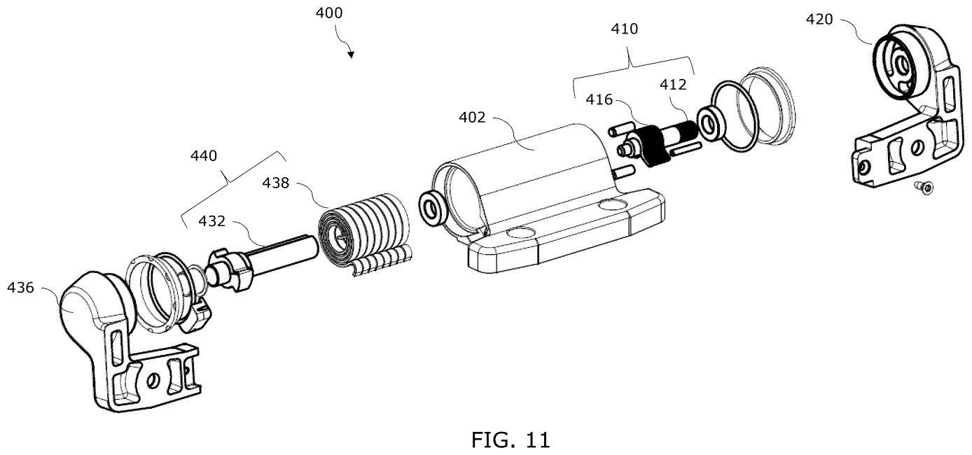

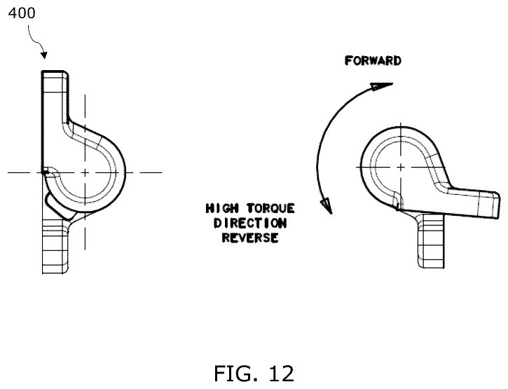

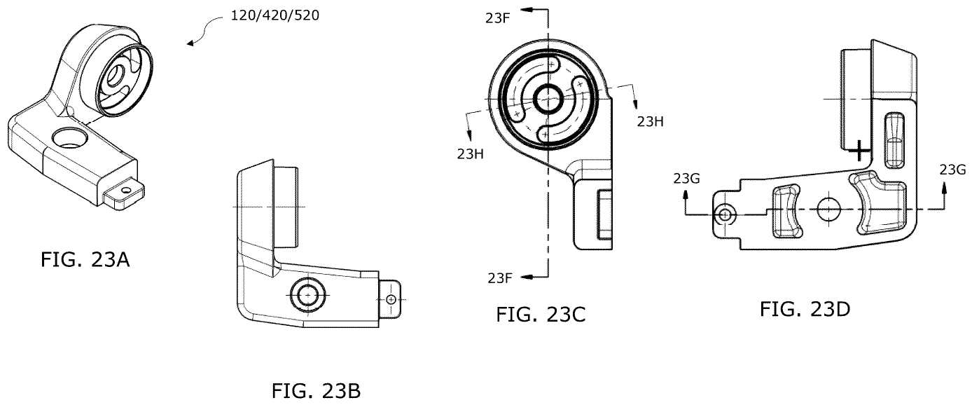

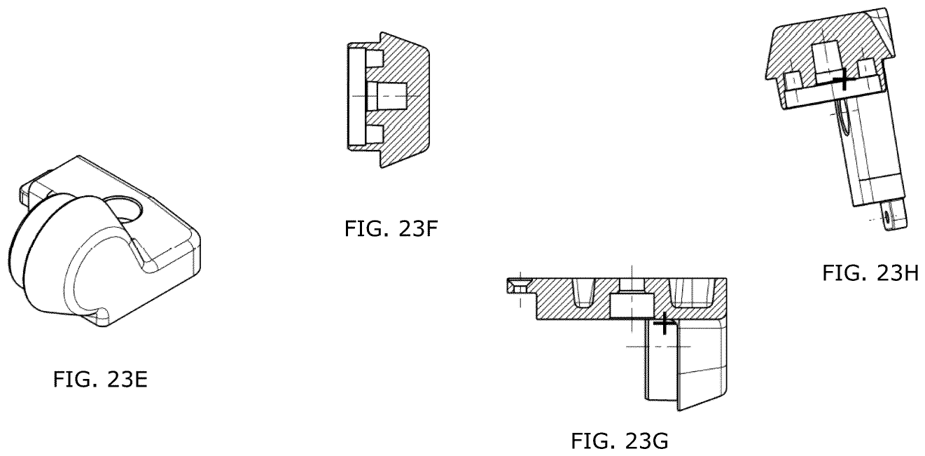

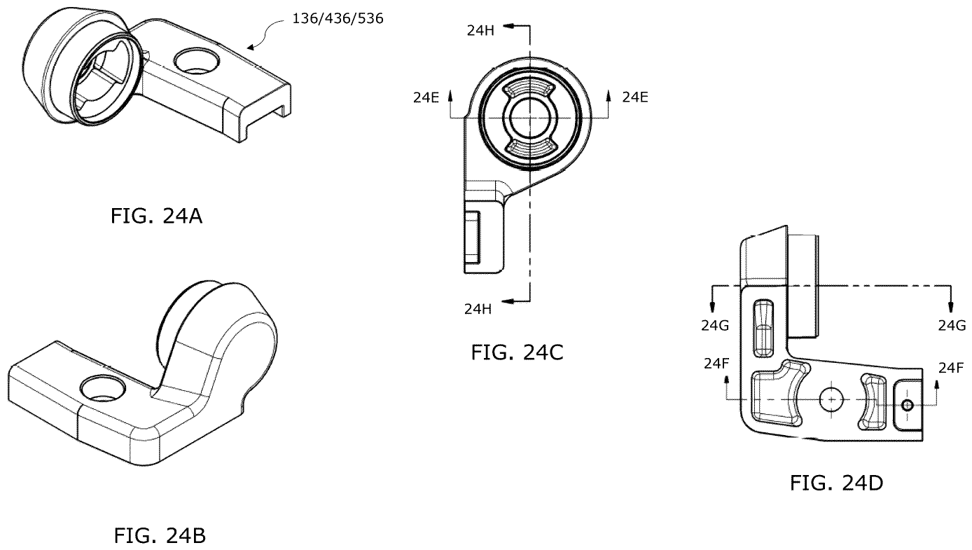

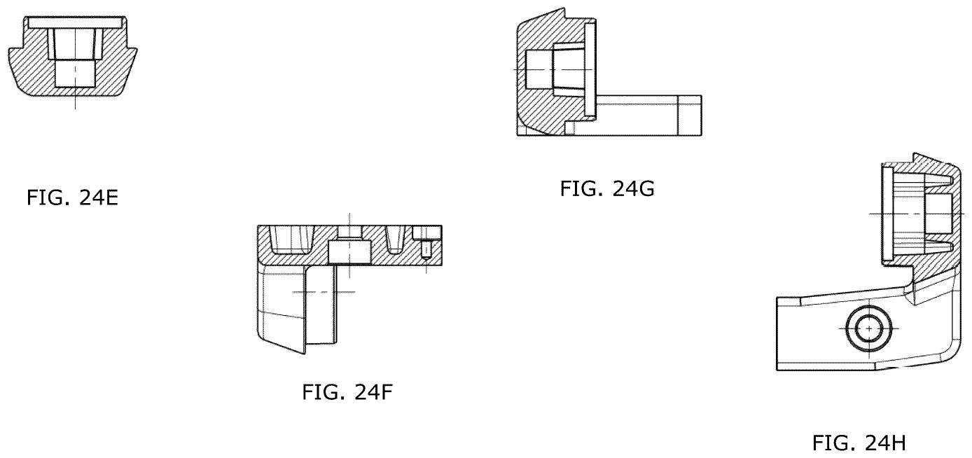

With reference to FIGS. 10A-10H, 11, and 12, a counterbalance hinge module in accordance with a fourth exemplary embodiment of the invention, showing the range of motion of a hinge module 400, is illustrated. The hinge module 400 is depicted in FIGS. 10A-10H, 11, and 12, and the details thereof generally correspond to the hinge modules 100, 200, 300 as described above. For example, hinge module 400 comprises a housing 402; a torque engine 410 comprising shaft 412 and torque element 416; a torque adjusting unit 440 comprising spring arbor 432 and spring 438; and movable adapters 420, 436. Hinge module 400 also comprises flange portions 434. Each of the components of hinge module 400 generally has similar details and function of the corresponding components of hinge module 100, 200, and/or 300, such as torque engine 110 comprising shaft 112 and torque element 116; a torque adjusting unit 140 comprising spring arbor 132 and spring 138; movable adapters 120, 136; and flange portions 234. However, they differ in some respects. In an exemplary embodiment, movable adapter 420 is illustrated in FIGS. 23A-23H and movable adapter 436 is illustrated in FIGS. 24A-24F. For example, the maximum operational angle (x°) between the first and second coupling components at the fully closed position or at the fully open position may different from that shown and/or described (e.g. in FIGS. 16D, 16H, and 17E).

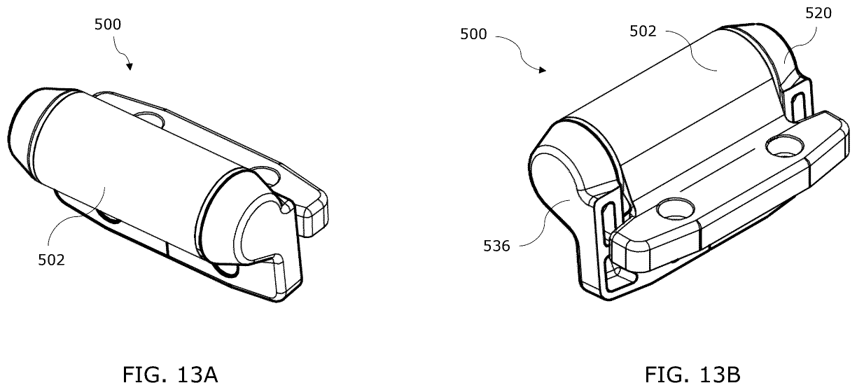

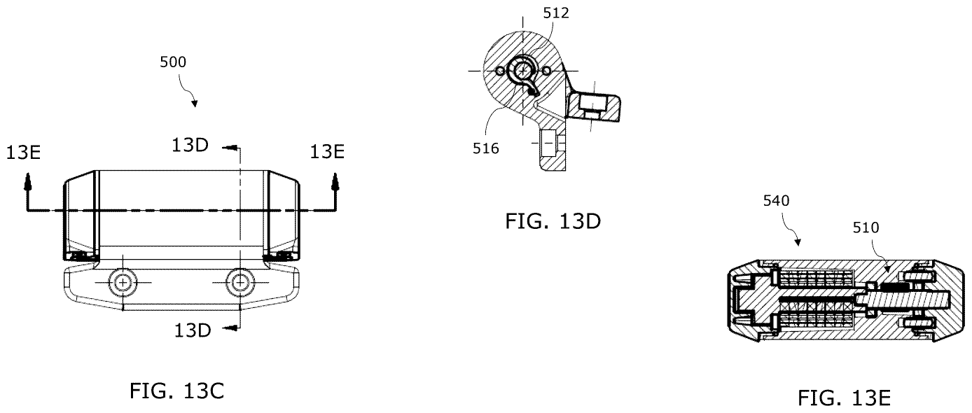

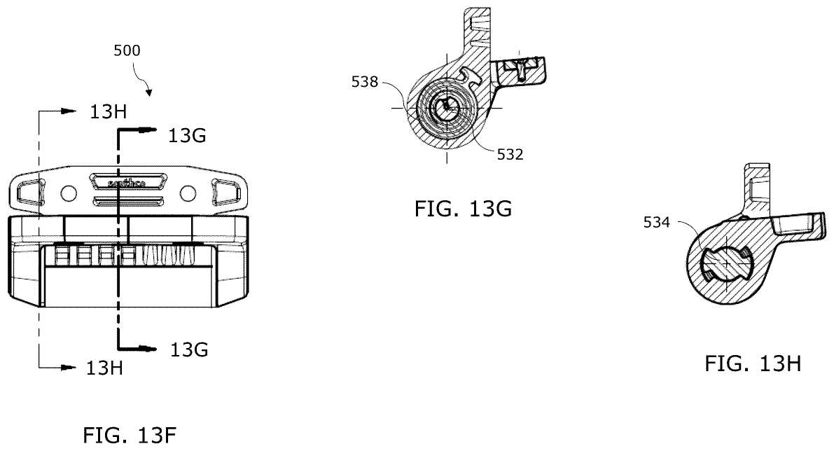

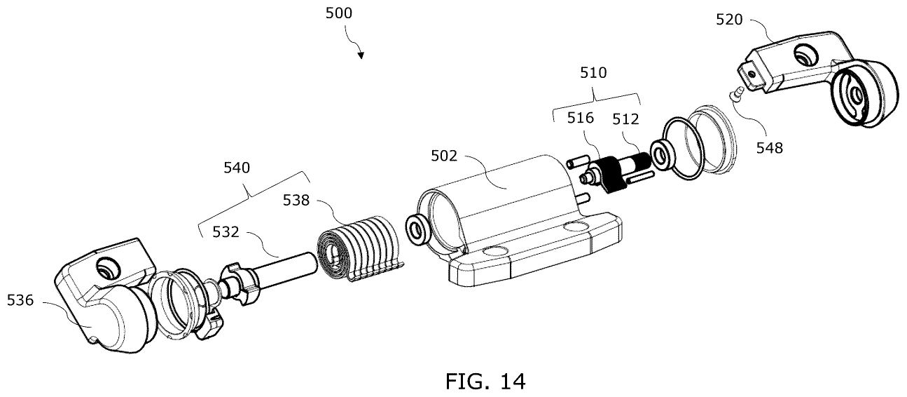

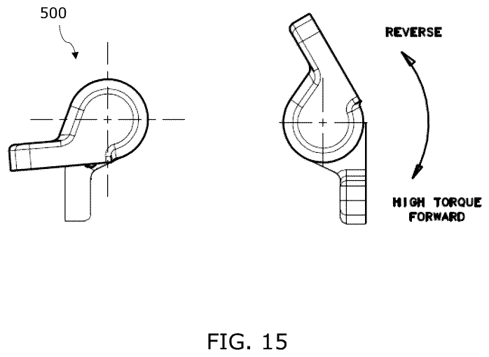

With reference to FIGS. 13A-13H, 14, and 15, a counterbalance hinge module in accordance with a fifth exemplary embodiment of the invention, showing the range of motion of a hinge module 500, is illustrated. The hinge module 500 is depicted in FIGS. 13A-13H, 14, and 15, and the details thereof generally correspond to the hinge modules 100, 200, 300, 400 as described above. For example, hinge module 500 comprises a housing 502; a torque engine 510 comprising shaft 512 and torque element 516; a torque adjusting unit 540 comprising spring arbor 532 and spring 538; and movable adapters 520, 536. Hinge module 500 also comprises flange portions 534. Each of the components of hinge module 500 generally has similar details and function of the corresponding components of hinge module 100, 200, 300, and/or 400, such as torque engine 110 comprising shaft 112 and torque element 116; a torque adjusting unit 140 comprising spring arbor 132 and spring 138; movable adapters 120, 136; and flange portions 234. However, they differ in some respects. In an exemplary embodiment, movable adapter 520 is illustrated in FIGS. 23A-23H and movable adapter 536 is illustrated in FIGS. 24A-24F. For example, the maximum operational angle (x°) between the first and second coupling components at the fully closed position or at the fully open position may different from that shown and/or described (e.g. in FIGS. 16D, 16H, and 17E).

FIGS. 16A-16K illustrate cross section views of an exemplary hinge module in accordance with aspects of the invention, to show position of one or more components of the hinge module at a neutral position. FIGS. 17A-17H also illustrate cross section views of an exemplary hinge module in accordance with aspects of the invention, to show position of one or more components of the hinge module at a neutral position.

This invention includes, but is not limited to, the following aspects:
1. A hinge for coupling components for pivotal movement relative to one another, the hinge comprising:
   a housing;
   a torque engine positioned within the housing and configured to provide frictional resistance to pivotal movement of the components, the torque engine comprising (i) a shaft defining a pivot axis, and (ii) at least one torque element frictionally engaging the shaft;
   a torque adjuster positioned within the housing, the torque adjuster comprising (i) a spring arbor having a first open end configured to receive a head of the shaft, and (ii) a spiral torsion spring configured to be wrapped around an exterior surface of the spring arbor to form a coiled body;
   wherein the coiled body comprises a number of rotations extending between a first spring end secured to the spring arbor and a second spring end secured to an interior surface of the housing, the number of rotations being selected to adjust the frictional resistance.
2. The hinge of aspect 1, wherein an outer diameter of the coiled body of the spiral torsion spring is selected to adjust the frictional resistance.
3. The hinge of aspect 1, further comprising an adapter having a mounting surface configured to be connected to one of the components.
4. The hinge of aspect 3, wherein the housing includes a hollow portion and a mounting portion, the mounting portion configured to be connected to the other of the components.
5. The hinge of aspect 3, wherein the components are configured for pivotal movement relative to one another along a first rotational direction.
6. The hinge of aspect 5, wherein the components are configured for pivotal movement relative to one another along a first rotational direction and second rotational direction, and the second rotational direction is different from the first rotational direction.
7. The hinge of aspect 6, wherein at least one of the (i) number of rotations of the spiral torsion spring and (ii) the outer diameter of the coiled body of the spiral torsion spring is selected to adjust the pivotal movement between the first rotational direction and the second rotational direction, thereby permitting reversible rotational.
8. The hinge of aspect 7, further comprising plural adapters.
9. The hinge of aspect 8, wherein a first adapter is configured for fixed coupling with a head of the spring arbor, and a second adapter is configured for fixed coupling with a distal end portion of the shaft.
10. The hinge of aspect 9, wherein the head of the spring arbor has a geometry selected to adjust the frictional resistance to pivotal movement of the coupling components.
11. The hinge of aspect 9, wherein the head of the spring arbor has a geometry selected to adjust the pivotal movement between the first rotational direction and the second rotational direction, thereby permitting reversible rotation.
12. The hinge of aspect 6, wherein the components are configured for pivotal movement relative to one another between a fully closed position and a fully open position.
13. The hinge of aspect 6, wherein at least one of (i) the number of rotations of the spiral torsion spring and (ii) the outer diameter of the coiled body of the spiral torsion spring is selected to adjust a maximum operational angle between components at the fully closed position and the fully open position.
14. The hinge of aspect 1, wherein lubricant is applied to an inner surface of the housing, the torsion adjuster, the torque engine, or a combination thereof.
15. The hinge of aspect 14, wherein the lubricant includes grease.
16. A hinged system comprising:
a first component;
a second component; and
a hinge coupling the first component to the second component in a pivot connection so as to allow pivotal movement of the first component relative to the second component, the hinge including:
   a housing;
   a torque engine positioned within the housing and configured to provide frictional resistance to pivotal movement of the first component and the second component, the torque engine comprising (i) a shaft defining a pivot axis, and (ii) at least one torque element frictionally engaging the shaft;
   a torque adjuster positioned within the housing, the torque adjuster comprising (i) a spring arbor having a first open end configured to receive head of the shaft, and (ii) a spiral torsion spring configured to be wrapped around an exterior surface of the spring arbor to form a coiled body;
   wherein the coiled body comprises a number of rotations selected to adjust the frictional resistance;
   wherein a mounting surface of an adapter is mounted to the first component; and
   wherein a mounting portion of the housing is mounted to the second component.
17. A hinge subassembly configured for use with components having pivotal movement relative to one another, the hinge subassembly comprising:
   a torque engine configured to provide frictional resistance to the pivotal movement of the components, the torque engine comprising (i) a shaft defining a pivot axis, and (ii) at least one torque element frictionally engaging the shaft; and
   a torque adjuster coupled to the torque engine and comprising (i) a spring arbor having a first open end configured to receive a head of the shaft, and (ii) a spiral torsion spring configured to be wrapped around an exterior surface of the spring arbor to form a coiled body;
wherein the coiled body comprises a number of rotations extending between a first spring end secured to the spring arbor and a second spring end secured to an interior surface of the housing, the number of rotations being selected to adjust the frictional resistance.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. A hinge for coupling components for pivotal movement relative to one another, the hinge comprising:
a housing;
a torque engine positioned within the housing and configured to provide frictional resistance to pivotal movement of the components, the torque engine comprising (i) a shaft defining a pivot axis, and (ii) at least one torque element frictionally engaging the shaft;
a torque adjuster positioned within the housing, the torque adjuster comprising (i) a spring arbor having a first open end configured to receive a head of the shaft, and (ii) a spiral torsion spring configured to be wrapped around an exterior surface of the spring arbor to form a coiled body;
wherein the coiled body comprises a number of rotations extending between a first spring end secured to the spring arbor and a second spring end secured to an interior surface of the housing, the number of rotations being selected to adjust the frictional resistance.

2. The hinge of claim 1, wherein an outer diameter of the coiled body of the spiral torsion spring is selected to adjust the frictional resistance.

3. The hinge of claim 1, further comprising an adapter having a mounting surface configured to be connected to one of the components.

4. The hinge of claim 3, wherein the housing includes a hollow portion and a mounting portion, the mounting portion configured to be connected to the other of the components.

5. The hinge of claim 3, wherein the components are configured for pivotal movement relative to one another along a first rotational direction.

6. The hinge of claim 5, wherein the components are configured for pivotal movement relative to one another along a first rotational direction and second rotational direction, and the second rotational direction is different from the first rotational direction.

7. The hinge of claim 6, wherein at least one of the (i) number of rotations of the spiral torsion spring and (ii) the outer diameter of the coiled body of the spiral torsion spring is selected to adjust the pivotal movement between the first rotational direction and the second rotational direction, thereby permitting reversible rotational.

8. The hinge of claim 7, further comprising plural adapters.

9. The hinge of claim 8, wherein a first adapter is configured for fixed coupling with a head of the spring arbor, and a second adapter is configured for fixed coupling with a distal end portion of the shaft.

10. The hinge of claim 9, wherein the head of the spring arbor has a geometry selected to adjust the frictional resistance to pivotal movement of the coupling components.

11. The hinge of claim 9, wherein the head of the spring arbor has a geometry selected to adjust the pivotal movement between the first rotational direction and the second rotational direction, thereby permitting reversible rotation.

12. The hinge of claim 6, wherein the components are configured for pivotal movement relative to one another between a fully closed position and a fully open position.

13. The hinge of claim 6, wherein at least one of (i) the number of rotations of the spiral torsion spring and (ii) the outer diameter of the coiled body of the spiral torsion spring is selected to adjust a maximum operational angle between components at the fully closed position and the fully open position.

14. The hinge of claim 1, wherein lubricant is applied to an inner surface of the housing, the torsion adjuster, the torque engine, or a combination thereof.

15. The hinge of claim 14, wherein the lubricant includes grease.

16. A hinged system comprising:
a first component;
a second component; and
a hinge coupling the first component to the second component in a pivot connection so as to allow pivotal movement of the first component relative to the second component, the hinge including:
a housing;
a torque engine positioned within the housing and configured to provide frictional resistance to pivotal movement of the first component and the second component, the torque engine comprising (i) a shaft defining a pivot axis, and (ii) at least one torque element frictionally engaging the shaft;
a torque adjuster positioned within the housing, the torque adjuster comprising (i) a spring arbor having a first open end configured to receive head of the shaft, and (ii) a spiral torsion spring configured to be wrapped around an exterior surface of the spring arbor to form a coiled body;
wherein the coiled body comprises a number of rotations selected to adjust the frictional resistance;
wherein a mounting surface of an adapter is mounted to the first component; and
wherein a mounting portion of the housing is mounted to the second component.

17. A hinge subassembly configured for use with components having pivotal movement relative to one another, the hinge subassembly comprising:
a torque engine configured to provide frictional resistance to the pivotal movement of the components, the torque engine comprising (i) a shaft defining a pivot axis, and (ii) at least one torque element frictionally engaging the shaft; and
a torque adjuster coupled to the torque engine and comprising (i) a spring arbor having a first open end configured to receive a head of the shaft, and (ii) a spiral torsion spring configured to be wrapped around an exterior surface of the spring arbor to form a coiled body;
wherein the coiled body comprises a number of rotations extending between a first spring end secured to the spring arbor and a second spring end secured to an interior surface of the housing, the number of rotations being selected to adjust the frictional resistance.
